(19) United States
(12) Patent Application Publication
(10) Pub. No.: US 2014/0175975 A1
(43) Pub. Date: Jun. 26, 2014

(54) CERAMIC METAL HALIDE LAMPS WITH CONTROLLED COLD SPOT

(71) Applicant: GENERAL ELECTRIC COMPANY, Schenctady, NY (US)

(72) Inventor: Zoltan TOTH, Budapest (HU)

(73) Assignee: GENERAL ELECTRIC COMPANY, Schenctady, NY (US)

(21) Appl. No.: 13/721,259

(22) Filed: Dec. 20, 2012

(51) Int. Cl. H01J 61/33

(52) U.S. Cl. CPC H01J 61/33
USPC 313/623

(57) ABSTRACT

Apparatus and methods for controlling the cold spot in a high-intensity discharge lamp. In an embodiment, an elongated arc tube has an inner wall defining a discharge chamber that includes a metal halide dose. A first leg extends from the arc tube in a first direction and a second leg extends from the arc tube in a second direction that is opposite the first direction. The first electrode is disposed within the first leg such that no voids exist between the first electrode and an entire inner portion of the first leg. Likewise, a second electrode disposed within the second leg has no voids between it and an entire inner portion of the second leg. The arc tube also has a first annular bucket structure within the discharge chamber formed by a nub surrounding the first tip and an interior wall portion, and a second annular bucket structure within the discharge chamber formed by a nub surrounding the second tip and a second interior wall portion. As a result, when the high-intensity discharge lamp is in a vertical operating position a cold spot is formed in one of the first and second annular bucket structures.

### FIELD OF THE INVENTION

The present disclosure relates to high intensity discharge lamps and more particularly to assemblies for controlling the location of a cold spot in an arc tube of the high intensity discharge lamp.

### BACKGROUND

The arc tube of a high intensity metal halide discharge lamp is typically made of translucent, transparent or substantially transparent quartz glass, hard glass, or ceramic arc tube materials. Such lamps may find application, for example in the general lighting area, including retail display lighting and public lighting, although it will be appreciated that selected aspects may find application in related discharge lamp environments for general lighting purposes. For present purposes, a “discharge chamber” relates to that part of a high intensity discharge lamp which encloses the arc discharge, while the term “arc tube” represents the minimal structural assembly of the discharge lamp required to generate light by exciting an electric arc discharge in the discharge chamber. An arc tube may also contain pinch seals having molybdenum foil and outer leads or lead wires (in the case of quartz arc tubes) or ceramic protruded end plugs or ceramic legs with seal glass seal portions and outer leads (in case of ceramic arc tubes) which ensure a vacuum tight enclosure for the discharge chamber. Opposing electrodes include inner terminals that are disposed within the discharge chamber, and the electrodes are typically electrically connected to electrical driver components via outer leads that protrude from seal portions of the arc tube assembly.

High intensity metal halide discharge lamps produce light by ionizing a fill or “dose” contained in the discharge chamber. The dose is typically a mixture of metal halides and a buffer agent such as mercury in an inert gas such as neon, argon, krypton or xenon or a mixture thereof. The inner terminal ends of the electrodes and the dose are sealed within the discharge chamber, which maintains a desired pressure of the energized dose. The arc is initiated in the discharge chamber between the inner terminal ends of the opposing electrodes, and the dose then emits visible electromagnetic radiation (light) with a desired spectral power density distribution (spectrum) in response to being vaporized and excited by the arc.

Conventional compact high intensity metal halide discharge lamps have a generally ellipsoidal or tubular discharge chamber that may be disposed in any orientation. During operation, the molten metal halide salt pool of an overdosed quantity often resides in the coldest part of the arc tube, which is often called a “cold spot” location. The overdosed molten metal halide salt pool, which is in thermal equilibrium and includes saturated vapor that develops above the dose pool within the discharge chamber, is situated at the cold spot. In a horizontal operating position, at least part of the halide dose is located at the bottom of the arc tube and forms a thin film layer on a significant portion of an inner wall surface of the discharge chamber. The molten metal halide salt pool (or dose pool) blocks or filters out a significant amount of light that is emitted from the arc discharge of the lamp. The dose pool thus distorts the spatial intensity distribution of the lamp by increasing light absorption and light scattering in directions where the dose pool sits in the chamber. Moreover, the dose pool alters the color hue of light that passes through the thin liquid film of the dose pool. In addition, the dose pool can lead to portions of the arc tube being subject to corrosion due to the liquid phase of the condensed metal halide. In a vertical operation mode, the dose is located at the bottom of the interior of the arc tube. The temperature at this location varies a great amount due to the actual position of the arc tube, hence altering the amount and the composition of the dose evaporated into the discharge space. Accordingly, photometric properties, especially the color of the lamp, might vary from lamp to lamp, or even for a certain lamp if the dose location varies even slightly by movement of the dose in the coldest region.

Accordingly, it would be beneficial to provide a controlled cold spot location for the dose pool in the discharge chamber of a high intensity metal halide discharge lamp that solves or minimizes the problems encountered by conventional high intensity discharge lamps as described above.

### SUMMARY OF THE INVENTION

Disclosed are apparatus and methods for controlling the cold spot in a high-intensity discharge lamp. In an embodiment, the high-intensity discharge lamp includes an elongated arc tube with an inner wall defining a discharge chamber that includes a metal halide dose. A first leg extends from the arc tube in a first direction and a second leg extends from the arc tube in a second direction that is opposite the first direction. A first electrode is disposed within the first leg, and no voids exist between the first electrode and an entire inner portion of the first leg. A second electrode is disposed within the second leg and it also has no voids between it and an entire inner portion of the second leg. In addition, the arc tube includes a first annular bucket structure within the discharge chamber formed by a nub that surrounds the first tip and an interior wall portion, and a second annular bucket structure within the discharge chamber formed by a second nub that surrounds the second tip and a second interior wall portion. When the high-intensity discharge lamp is in a vertical position a cold spot is formed in one of the first and second annular bucket structures.

Advantageously, when the high-intensity discharge lamp is in the vertical position, one of the first and second annular bucket structures prevents the dose from reaching the electrode tip. In an embodiment, one of the first and second annular bucket structures contains the dose such that the dose is located a distance of at least 1.0 mm away from the electrode tip.

### BRIEF DESCRIPTION OF THE DRAWINGS

FIG. 1A is a cross-sectional view of a typical high intensity discharge lamp;

FIG. 1B is a cross-sectional view of another typical high intensity discharge lamp; and

FIG. 2 is a cross-sectional view of a high intensity discharge lamp including an arc tube having a discharge chamber with an annular bucket-shaped structure according to an embodiment of the invention.

### DETAILED DESCRIPTION

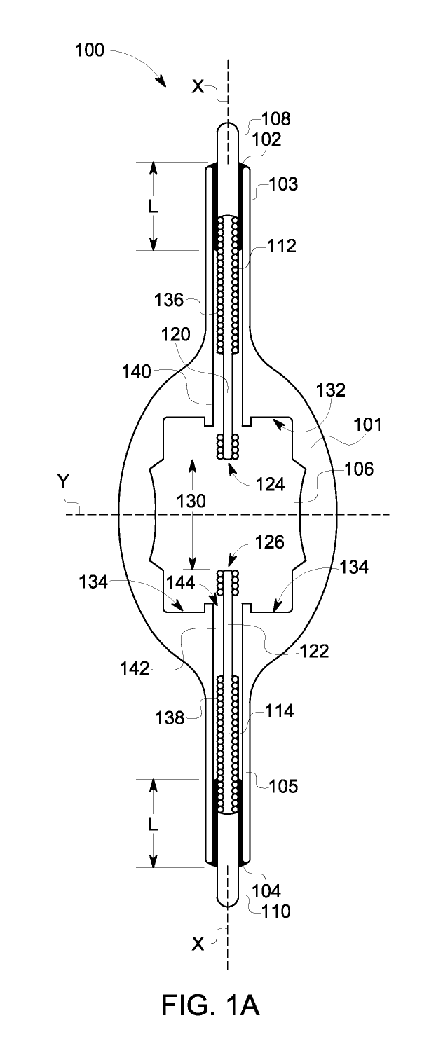

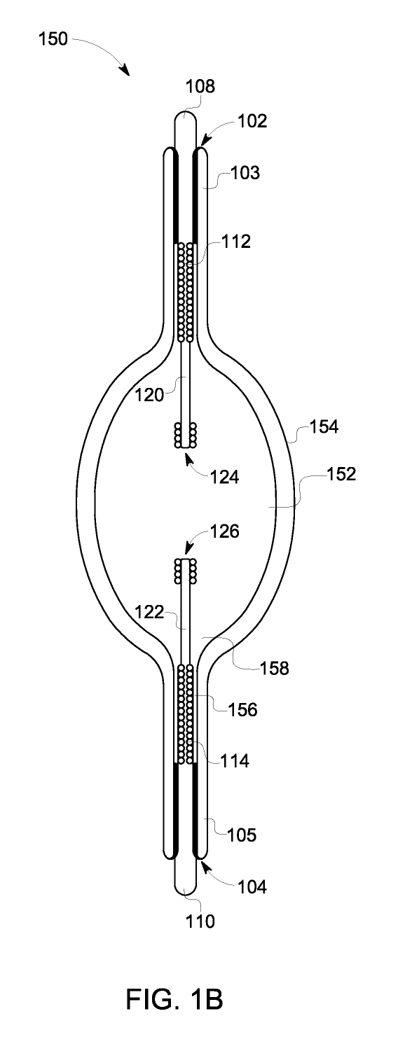

FIG. 1A is a cross-sectional view of a typical high intensity discharge lamp 100 that includes an arc tube 101. First and second sealed ends 102, 104 are disposed at opposite ends of the arc tube 101 and at distal ends of first and second legs 103, 105. The discharge chamber 106 is substantially rotationally symmetric about the longitudinal axis “X”, and is substantially symmetric about a central lateral axis “Y” that is located substantially halfway between the inner terminal ends of the electrodes. As shown, the lateral “Y” axis is perpendicular to the longitudinal axis “X”. As will also be appreciated from FIG. 1A, opposing lateral walls of the discharge chamber 106 may define a generally cylindrical shape. The outer surface of the 101 arc tube can also be cylindrical, or can be elliptical as shown in FIG. 1A. The arc tube 101 may be composed of a substantially transparent material, such as a ceramic arc tube material, and the inner walls define a discharge chamber 106. Outer leads 108, 110 have outer terminal end portions that extend outwardly from each of the sealed ends 102, 104. A typical alumina arc tube construction includes leads 108, 110 that are made of niobium to have a similar coefficient of heat expansion (CTE) as the alumina material of the arc tube itself. In some embodiments, the outer leads 108, 110 join in mechanical and electrical interconnection with intermediate conductive portions 112, 114, respectively, which may be made of conductive metals such as molybdenum, and which are embedded within the legs 103, 105. There are constructions to minimize the stress in these cases which are known to those skilled in the art. The intermediate metal conductive portions 112, 114 are joined to the electrode tips 120 and 122, respectively. The electrode tips 120, 122 may be made of tungsten, because tungsten has a high melting point and low sublimation at high temperatures. It should be understood that the outer lead 108, intermediate conductive portion 112 and electrode tip 120 together form a first electrode, and the outer lead 110, intermediate conductive portion 114 and electrode tip 122 together form a second electrode.

The hermetic closure of the arc tube is ensured by melting a sealing material and having it flow from the seal ends 102, 104 into the leg portions. The arrows labeled “L” represents the seal length for each of the legs 103, 105, which is the distance or length that the sealing material infiltrates within each of the legs 103, 105. As shown in FIG. 1A, a portion of the legs 103 and 105 between the inner walls of the ceramic leg material and the intermediate conductive portions 112, 114 is not filled with sealing material. Thus, a void 136 may be created between the intermediate conductive portion 112 and inner wall of the ceramic leg 103 and a void 138 may be created between the intermediate conductive portion 114 and inner wall of the ceramic leg 105. In addition, there is an empty space or void 140 between the ceramic leg 103 and electrode tip 120, and an empty space or void 142 between the ceramic leg 105 and the electrode tip 122. Accordingly, voids 136 and 140 surround the electrode 120, and voids 138, 142 surround the electrode tip 122.

As shown, the electrode tips 120, 122 terminate in electrode end points or inner terminals 124 and 126, respectively. The distance 130 between the inner terminals 124 and 126 is referred to as an arc gap. As is known, in response to a voltage applied between the first and second outer leads 108, 110, an arc is formed between the inner terminals 124, 126. An ionizable dose material sealed within the discharge chamber 106 of the lamp responds to the voltage applied between the inner terminals 124, 126 to reach a discharge state. (The dose typically includes a mixture of metal halides as well as an inert starting gas or a mixture thereof and optionally Hg.) In a horizontally-oriented operational state of the discharge lamp, a liquid phase portion of the dose is usually situated in a central bottom portion of the horizontally disposed discharge chamber 106. As explained above, in some circumstances such a metal halide salt pool or dose pool can adversely impact lamp performance and light color, and may shade the light to adversely impact the spatial light intensity distribution emitted from the lamp.

Referring again to FIG. 1A, the high intensity discharge lamp 100 is depicted in a vertical burn position. As shown in FIG. 1A, in the locations surrounding the inner terminals 124, 126, a first ledge 132 and a second ledge 134 have been formed in the inner portion of the arc tube. The first and second ledges 132, 134 form a ring or moat that encircles each of the inner terminals 124, 126. During operation in the vertical orientation of the lamp, the liquid dose starts to fill the voids in the leg. If the leg 105 is positioned closest to the floor (as shown in FIG. 1A), then during operation the liquid dose acting under gravity flows downward through opening 144 to first fill the void 138, and if enough dose is present than it may also partially fill the void 142 next to the electrode 122. If more dose was added, for example, to achieve required color properties, then the liquid dose may fill up the void 142 entirely and then will start to enter into the discharge space. In such a case the second ledge 134, which forms the moat about the inner terminal 126, constitutes a cold spot location (but if the arc tube is illuminated in the opposite vertical position, or an upside-down orientation to that shown in FIG. 1A, then the first ledge 132 would constitute a cold spot location around the inner terminal 124). The ledges 132, 134 thus form containers for the excess liquid metal halide salt pools that are displaced along an axial direction of the arc tube away from the central arc gap region defined between the inner terminal tips of the electrodes, and are located axially outward of the inner terminal tips of the electrodes as well as away from the center of the discharge chamber.

Referring again to FIG. 1A, during vertical operation the liquid dose may be contained on the moat or ledge 134 (or on the ledge 132 if the arc tube is operating in an upside-down position), which may occur if the lamp is operated at a certain angle to the vertical line. During the operation of the lamp, the liquid dose can move about in the ledge 134, due to wetting properties between the dose and the ledge 134 (the ledge 134 may be composed of the same material as the arc tube, e.g., alumina). The temperature in the different locations along the ledge can change very rapidly as the dose moves in a direction away from the electrode. So as the dose changes its location due to wetting or convection, the temperature of the coldest point also changes which results in a change of the vapor pressure above the dose pool. Then different amounts of dose enter into the plasma which eventually changes the lamp photometric properties, including both lumen output and color. In some applications, such as retail display usage, uniform color distribution of the entire illuminated area is essential, but the arc tube of FIG. 1A can operate in a manner that changes the color of a certain point illuminated by that particular individual lamp, as well as causing color differences in between adjacent areas illuminated mainly by different lamps.

FIG. 1B is a cross-sectional view of another implementation of a typical high intensity discharge lamp 150 having a discharge chamber 152 that has a different inner shape than the discharge chamber 106 of FIG. 1A. However, the outer shape of the arc tube 154 is generally elliptical, or similar in shape to the arc tube 101 of FIG. 1A. The reference numbers used in FIG. 1B that refer to like elements of FIG. 1A have the same reference numbers as FIG. 1A (which elements are described above). Similarly to the construction described above with regard to FIG. 1A, during vertical operation of the lamp (or close to vertical operation), due to gravity the liquid dose first fills up the void 156 next to the intermediate conductive portion 114 and inner wall of the ceramic leg 105, then enters the neck portion 158 void next to the electrode tip. As the leg continues upwards into the elliptical body of the arc tube, the neck portion 158 gradually gets wider and thus the dose eventually enters the neck portion 158. In the construction of FIG. 1B, the liquid dose can change its temperature in the same manner explained above with regard to FIG. 1A. In this case, the dose may also come into direct contact with the electrode tip 122 and the hot inner terminal 126. Due to wetting and convection, the dose will change its location either along the electrode 122 or in the entire neck portion 158 caused by the convection due to the large heat gradient between the hot electrode tip and the wall, e.g., an alumina wall. The result is the same type of color spread problems and associated drawbacks described above in connection with the construction shown in FIG. 1A.

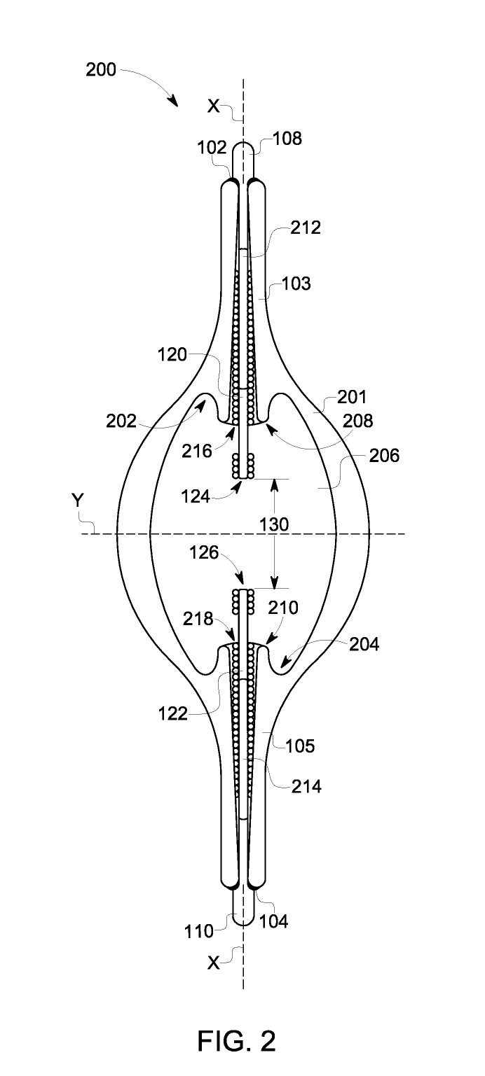

FIG. 2 is a cross-sectional view of a high intensity discharge lamp 200 according to an embodiment, wherein like elements with regard to FIGS. 1A and 1B have been labeled with same reference numbers. The high intensity discharge lamp includes an arc tube 201 having a discharge chamber 206 that includes bucket-shaped moat constructions 202 and 204. First and second sealed ends 102, 104 are disposed at opposite ends of the arc tube 201 at distal ends of the first and second legs 103, 105. The arc tube may be composed of a substantially transparent material, such as ceramic material like polycrystalline alumina (PCA), and the inner walls of the arc tube define a discharge chamber 206. Outer leads 108, 110 have outer terminal end portions that extend outwardly from each of the sealed ends 102, 104 and have portions within the legs 103, 105. In some embodiments, the outer leads 108, 110 are mechanically and electrically joined to wires 212, 214 (or another type of conductor) embedded within the legs 103, 105. First and second electrode tips 120, 122 have portions that are similarly mechanically and electrically joined to the wires 212, 214. The electrode tips 120, 122 are terminated with inner terminals 124, 126, respectively, that extend into the discharge chamber 206. The inner terminal 124 is separated from the inner terminal 126 along a longitudinal axis “X” by an arc gap 130. The discharge chamber 206 of FIG. 2 is substantially rotationally symmetric about the longitudinal axis “X”, and is substantially symmetric about a central lateral axis “Y” that is located substantially halfway between the inner terminals 124, 126. As shown, the lateral “Y” axis is perpendicular to the longitudinal axis “X”. As will also be appreciated from FIG. 2, the wall thickness of the arc tube 201 may vary which may be due to manufacturing methods, tolerances, and/or design choice. Similarly to FIG. 1A, outer lead 108 plus conductor 212 and electrode tip 120 form the first electrode, and outer lead 110 plus conductor 214 and electrode tip 122 form the second electrode.

During manufacture of the arc tube 201, as shown in FIG. 2, bucket-shaped moat constructions 202 and 204 are formed within the discharge chamber 206 near inner portions of the legs 103, 105 and surrounding the electrode tips 120 and 122, respectively. The bucket-shaped moat constructions include nubs 208, 210 or protuberances that extend from the legs into the discharge chamber 206. The nubs 208, 210 and the inner wall portions of the arc tube closest to the legs together form the pocket or moat for catching or containing the dose when the discharge lamp is in vertical operation. In addition, the electrode tips 120, 122 are fed through the legs 103, 105 into the discharge chamber 206 in a manner that eliminates any voids between the electrodes and the legs. In some embodiments, this is accomplished by allowing seal glass to flow into the voids during manufacture such that the seal glass flow reaches the end of the nubs 208,210 to eliminate any voids. In this case, seals 216, 218 are formed between terminal end portions of the electrode tips 120, 122 and the legs 103, 105 such that any void that may have otherwise been present there-between is eliminated. The sealant utilized to form the seals 216, 218 may be any types of seal glass compositions such as an appropriate mixture of dysprosia, alumina and silica, or any of the many well-known types of seal glass composition. In another construction cermet material can be utilized instead of having intermediate metal wires 212, 214. In these cases the hermetic closure of the arc tube interior can be accomplished by utilizing regular seal glass, as described previously, provided that the sealing also ends at the top of the nub 210. Alternatively, co-sintered cermets instead of sealing glass can also be used, so long as the cermet ends at the same level as the end portion of the nub 210.

Instead of a wire or metallic electrode assembly as depicted in FIG. 2, the interior portions of the legs 103, 105 may be composed of an electrically conductive cermet material, such as a co-sintered cermet (a composite of ceramic and metal, compressed together in to an electrically conductive ceramic). Such an assembly or configuration may also be achieved by use of a co-sintered cermet electrode or by use of a ceramic co-sintered with an appropriate metal conductor fed there-through. In any case, during manufacture of the arc tube lamp, the cermet electrodes are fed through the legs such that there are no voids or spaces between the legs and the electrode assemblies. Thus, during vertical operation of the lamp none of the dose can be located next to the electrodes in the legs (because there are no voids in those areas). Accordingly, during vertical operation of the discharge lamp 200 as shown in FIG. 2, the dose can only be located in the pocket of the bucket-shaped moat construction 204. The outlined construction has two advantages. First, there is no direct contact between the dose and the electrode. Hence any rapid change in the effective cold spot temperature change caused by wetting and/or the dose approaching the electrode is eliminated. In the case of a sealing glass construction, due to the lack of direct contact between the dose and the glass itself corrosive reaction between the two materials is eliminated. Furthermore, the pocket or moat is configured such that the dose remains in a well-defined pocket, and the temperature changes slowly and monotonically along the pocket on both ends. It should be understood that the pocket must be constructed in a manner such that when the dose fills the pocket, the dose still is at least 0.5 millimeter (0.5 mm) away from the top of the nub 210 (or at least this distance (0.5 mm) away from the electrode tip 122). (In some implementations, when the dose fills the pocket it is at least 1.0 mm away from the electrode tip 122.) In this manner during vertical operation direct contact with the hot electrode can be avoided. In addition, the temperature gradient along the outer surface of the nub is low enough not to cause serious color change if and/or when wetting and dose climbing occurs on the inner surface wall of the discharge chamber. Accordingly, a stable vapor pressure is achieved, which results in a stable correlated color temperature (CCT) of the discharge lamp 200.

Thus, during operation of the lamp 200 in the vertical orientation as shown, the dose deposits in the cold spot that is well defined by the bucket-shaped moat structure 204 (and in some implementations the dose may be allowed to “roll around” in the moat 204). But in any case such a construction still limits the liquid dose to the pocket (cold spot) in a well-defined manner during operation of the lamp so that variations in the vapor pressure of the metal halide in the gas phase are minimized or non-existent, which results in a steady color of the lamp (no fluctuations in color). Furthermore, the liquid dose does not contact the seal glass or the metal conductor of the electrode assemblies, so corrosion is minimized which may lead to extending the useful life of the discharge lamp (although the gas form of the dose may still corrode the electrode assemblies over time, such a process is much slower than that involving the liquid dose). Furthermore, the nub may be designed to have a particular curvature to reduce steady state and/or transient stresses at the neck portion of the legs, which may increase discharge lamp reliability.

During operation, as explained above, in response to a voltage applied between the first and second outer leads, an arc forms between the inner terminals 124, 126 of the electrodes. The ionizable dose material sealed within the discharge chamber 206 of the lamp thus reaches a discharge state in response to the voltage applied between the outer leads and as the discharge lamp operates and reaches equilibrium, the dose is present in both a liquid and gas phase. The liquid phase portion of the dose seeks a cold spot location under the force of gravity and thus situates in the bucket-shaped moat construction 204 within the discharge chamber 206. Since there are no voids present between the electrodes and the legs of the discharge lamp 200, the liquid dose is forced to the only well-defined cold spot available (the moat construction 204) which surrounds the electrode 122.

In some embodiments, the composition of the dose generally includes at least a buffer gas, mercury and at least one alkali metal halide. The dose may further include least one rare earth halide. Also, alkaline earth metal halides such as halides of Magnesium (Mg), Barium (Ba), or Calcium (Ca) may be present. Halides may also include chloride, bromide and/or iodide. Examples of alkali metal halides may include NaI, LiI and KI, or the like. Suitable quantities of Mercury (Hg) may also be present. In addition, a buffer gas including an inert gas such as Argon (Ar), Krypton (Kr) and/or Xenon (Xe) may be present. Examples of suitable or usable buffer gas pressures may include from about 200 to about 300 mBar, but other values are possible. Thus, when the electric arc passes through the vaporized metal halide (such as NaI) of the dose, the NaI provides luminous flux while the rare earth iodide provides color to the light, due to electrical excitation of the rare earth atoms. A steady, substantially constant value for the vapor pressure of the rare earth iodide should be present in the arc discharge (during operation), so that the color does not fluctuate.

In some embodiments, the discharge lamp may be configured to operate to provide 70 Watts of illumination, although other configurations are contemplated. In addition, in some embodiments the rare earth halide present in the dose is lanthanum halide, but the use of other rare earth halides or combinations thereof are contemplated.

Embodiments of a high intensity discharge lamp have been described herein in the context of designing lamps for applications such as retail location lighting, high bay lighting, street lighting (outdoor lighting), but it should be understood that other indoor and outdoor applications are possible.

The above description and/or the accompanying drawings are not meant to imply a fixed order or sequence of steps for any process referred to herein; rather any process may be performed in any order that is practicable, including but not limited to simultaneous performance of steps indicated as sequential.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A high-intensity discharge lamp comprising:
an elongated arc tube including an inner wall that defines a discharge chamber;
a first leg extending from the arc tube in a first direction and a second leg extending from the arc tube in a second direction that is opposite the first direction;
a first electrode disposed within the first leg and having a first tip extending into the discharge chamber, wherein no voids exist between the first electrode and an entire inner portion of the first leg;
a second electrode disposed within the second leg and having a second tip extending into the discharge chamber opposite the first tip, wherein the first tip and the second tip define an arc gap therebetween, and wherein no voids exist between the second electrode and an entire inner portion of the second leg;
a dose disposed in the discharge chamber, the dose comprising alkali metal halide and at least one rare earth halide; and
wherein the arc tube includes a first annular bucket structure within the discharge chamber formed by a nub that surrounds the first tip and an interior wall portion, and a second annular bucket structure within the discharge chamber formed by a second nub that surrounds the second tip and a second interior wall portion, such that when the high-intensity discharge lamp is in a vertical position a cold spot is formed in one of the first and second annular bucket structures.

2. The lamp of claim 1, wherein during vertical operation one of the first and second annular bucket structures prevents the dose from reaching the electrode tip.

3. The lamp of claim 2, wherein the one of the first and second annular bucket structures contains the dose such that the dose is located a distance of at least 1.0 mm away from the electrode tip.

4. The lamp of claim 1, wherein during vertical operation the dose is in a saturated mode having a liquid state portion and a gaseous state portion of the halide dose.

5. The lamp of claim 1, wherein the first and second electrodes comprise tungsten.

6. The lamp of claim 1, wherein at least one of the first leg and the second leg comprises a cermet material in at least a portion thereof, wherein the cermet material adjacent to the discharge chamber is configured to deliver current to the electrode tip.

7. The lamp of claim 1, wherein the electrode of at least one of the first and the second leg comprises an electrode tip electrically connected to a wire sealed completely with a high temperature sealant within the leg, and a terminal end electrically connected to the wire and protruding from a distal end of the leg.

8. A method for controlling a cold spot in a high-intensity discharge lamp comprising:
providing an elongated arc tube including an inner wall that defines a discharge chamber;
providing a first leg extending from the arc tube in a first direction and a second leg extending from the arc tube in a second direction that is opposite the first direction;
providing a first electrode disposed within the first leg and having a first tip extending into the discharge chamber, wherein no voids exist between the first electrode and an entire inner portion of the first leg;
providing a second electrode disposed within the second leg and having a second tip extending into the discharge chamber opposite the first tip, wherein the first tip and the second tip define an arc gap therebetween, and wherein no voids exist between the second electrode and an entire inner portion of the second leg;
provide a dose disposed in the discharge chamber, the dose comprising alkali metal halide and at least one rare earth halide;
providing a nub that surrounds the first tip within the discharge chamber to form a first annular bucket structure; and
providing a nub that surround the second tip within the discharge chamber to form a second annular bucket structure;
wherein when the high-intensity discharge lamp is in a vertical position during operation a cold spot is formed in one of the first and second annular bucket structures.

9. The method of claim 8, wherein one of the first and second annular bucket structures prevents the dose from reaching the electrode tip.

10. The lamp of claim 9, wherein the dose is contained in one of the first and second annular bucket structures such that the dose is located a distance of at least 1.0 mm away from one of the first and second electrode tips.

11. The method of claim 8, wherein the dose is in a saturated mode having a liquid state portion and a gaseous state portion of the halide dose.

12. The method of claim 8, wherein the first and second electrodes comprise tungsten.

13. The method of claim 8, wherein providing at least one of the first leg and the second leg comprises utilizing a cermet material in at least a portion thereof, wherein the cermet material adjacent to the discharge chamber is configured to deliver current to at least one of the first and second electrode tips.

14. The method of claim 8, wherein providing at least one of the first and second electrodes comprises electrically connecting at least one of the first and the second electrode tip to a wire sealed completely with a high temperature sealant within the at least one of the first and second legs, and electrically connecting at least a first or a second terminal end to the wire.
